(19) United States
(12) Patent Application Publication
(10) Pub. No.: US 2020/0158150 A1
(43) Pub. Date: May 21, 2020

(54) MOUNTING ASSEMBLY

(71) Applicants: INVENTEC (PUDONG) TECHNOLOGY CORPORATION, Shanghai City (CN); INVENTEC CORPORATION, Taipei City (TW)

(72) Inventors: Wei-Han SU, Taipei City (TW); Yan Ru CHEN, Taipei City (TW)

(73) Assignees: INVENTEC (PUDONG) TECHNOLOGY CORPORATION, Shanghai City (CN); INVENTEC CORPORATION, Taipei City (TW)

(21) Appl. No.: 16/210,869

(22) Filed: Dec. 5, 2018

(30) Foreign Application Priority Data
Nov. 21, 2018 (CN) 201811388850.8

(51) Int. Cl. F16B 5/02; F16B 39/24

(52) U.S. Cl. CPC F16B 5/0266; F16B 5/0208; F16B 39/24

(57) ABSTRACT

This disclosure relates to a mounting assembly including a screw, an elastic component and a first base. The screw includes a head part, a neck part and an engaging part. The head part and the engaging part are respectively connected to two opposite sides of the neck part which is disposed through the elastic component. The elastic component includes a first side and a second side opposite to each other. The first side presses against the head part. The first base includes a first screw hole. The neck part is disposed through the first screw hole. The head part and the engaging part are respectively located at tow opposite sides of the first base. The second side of the elastic component presses against the first base. In addition, a largest outer diameter of the engaging part is larger than a smallest inner diameter of the first screw hole.

### CROSS-REFERENCE TO RELATED APPLICATIONS

This non-provisional application claims priority under 35 U.S.C. § 119(a) on Patent Application No(s). 201811388850.8 filed in China, P.R.C. on Nov. 21, 2018, the entire contents of which are hereby incorporated by reference.

### TECHNICAL FIELD

The present disclosure relates to a mounting assembly, more particularly to a mounting assembly having screws.

### BACKGROUND

Usually, the conventional server uses captive screws to secure various modules, and the captive screws is riveted to the modules so as to remain in the modules when loosened. This prevents the captive screws from being missing and saves time on pairing the captive screws with the screw holes. In addition, the male threads of the captive screws are usually softer than the female threads of the screw holes, which the female threads are made according to general specifications, so as to allow the captive screw to be deformed slightly thus to be screwed tightly, and it requires a spring to enhance the engaging force.

### SUMMARY

According to one aspect of the present disclosure, a mounting assembly includes a screw, an elastic component and a first base. The screw includes a head part, a neck part and an engaging part. The head part and the engaging part are respectively connected to two opposite sides of the neck part. The neck part is disposed through the elastic component. The elastic component includes a first side and a second side opposite to each other. The first side presses against the head part. The first base includes a first screw hole. The neck part is disposed through the first screw hole. The head part and the engaging part are respectively located at two opposite sides of the first base. The second side of the elastic component presses against the first base. In addition, a largest outer diameter of the engaging part is larger than a smallest inner diameter of the first screw hole.

According to another aspect of the present disclosure, a mounting assembly includes a screw, an elastic component, a first base and a second base. The screw includes a head part, a neck part and an engaging part. The head part and the engaging part are respectively connected to two opposite sides of the neck part. The neck part is disposed through the elastic component. The elastic component includes a first side and a second side opposite to each other. The first side presses against the head part. The first base includes a first screw hole. The neck part is disposed through the first screw hole. The head part and the engaging part are respectively located at two opposite sides of the first base. The second side of the elastic component presses against the first base. The second base includes a second screw hole. The engaging part is detachably disposed to the second base via the second screw hole. In addition, a largest outer diameter of the engaging part is larger than a smallest inner diameter of the first screw hole. The elastic component is compressed by the head part and the first base.

### BRIEF DESCRIPTION OF THE DRAWINGS

The present disclosure will become more fully understood from the detailed description given hereinbelow and the accompanying drawings which are given by way of illustration only and thus are not intending to limit the present disclosure and wherein:

FIG. 1 is a cross-sectional view of a mounting assembly according to one embodiment of the present disclosure;

FIG. 2 is an exploded cross-sectional view of the mounting assembly in FIG. 1;

FIG. 3 is an enlarged cross-sectional view showing that an engaging part is screwed in a first screw hole of a first base of the mounting assembly in FIG. 1;

FIG. 4 is a cross-sectional view of a mounting assembly according to another embodiment of the present disclosure;

FIG. 5 is a cross-sectional view of a mounting assembly according to yet another embodiment of the present disclosure;

FIG. 6 is a cross-sectional view of a mounting assembly according to still another embodiment of the present disclosure;

FIG. 7 is a cross-sectional view of an elastic component of a mounting assembly according to still yet another embodiment of the present disclosure;

FIG. 8 is a cross-sectional view of a mounting assembly according to still yet another embodiment of the present disclosure; and

FIG. 9 is a cross-sectional view of a mounting assembly according to still yet another embodiment of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

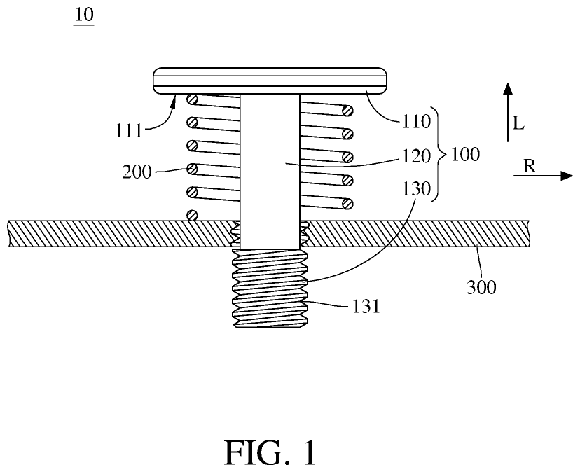

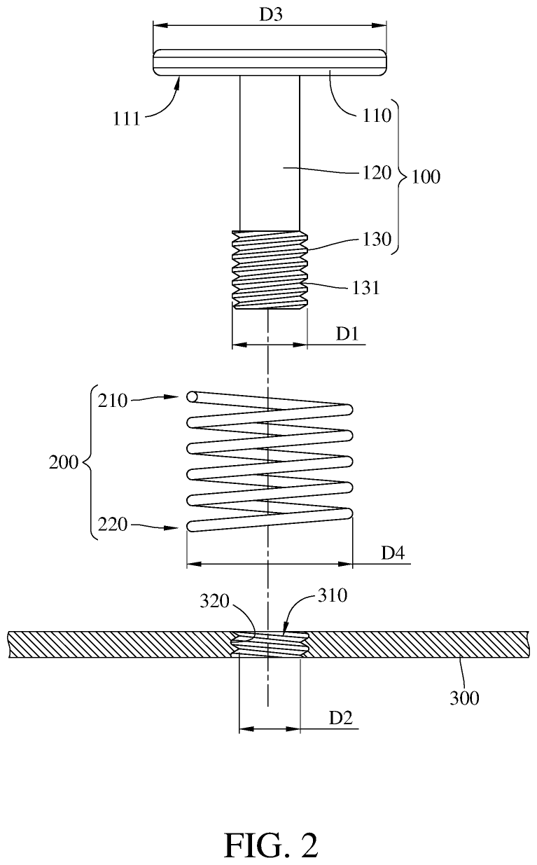

Please refer to FIG. 1 to FIG. 2, wherein FIG. 1 is a cross-sectional view of a mounting assembly according to one embodiment of the present disclosure, and FIG. 2 is an exploded cross-sectional view of the mounting assembly in FIG. 1.

In this embodiment, a mounting assembly 10 (e.g., a portion of a server casing that has a screw) includes a screw 100, an elastic component 200 and a first base 300. The screw 100 includes a head part 110, a neck part 120 and an engaging part 130. The head part 110 and the engaging part 130 are respectively connected to two opposite sides of the neck part 120; that is, the neck part 120 is located between and connected to the head part 110 and the engaging part 130. The neck part 120 is disposed through the elastic component 200. The elastic component 200 is, for example, a compression spring and includes a first side 210 and a second side 220 opposite to each other. The first side 210 presses against the head part 110. The first base 300 includes a first screw hole 310. The neck part 120 is disposed through the first screw hole 310. The head part 110 and the engaging part 130 may be respectively located at two opposite sides of the first base 300. The second side 220 of the elastic component 200 presses against the first base 300; that is, the elastic component 200 is compressed and located between the head part 110 and the first base 300.

Accordingly, the amount of the movement of the elastic component 200 is restricted by the head part 110 and the first base 300 along a longitudinal direction L of the screw 100. The head part 110 covers the first screw hole 310, but the disclosure is not limited thereto. In some other embodiments, only a part of the head part may cover the first screw hole. In this embodiment, a largest outer diameter D1 of the engaging part 130 is larger than a smallest inner diameter D2 of the first screw hole 310 in a radial direction R. As a result, the amount of the movement of the screw 100 is restricted by the head part 110 and the engaging part 130 along the longitudinal direction L.

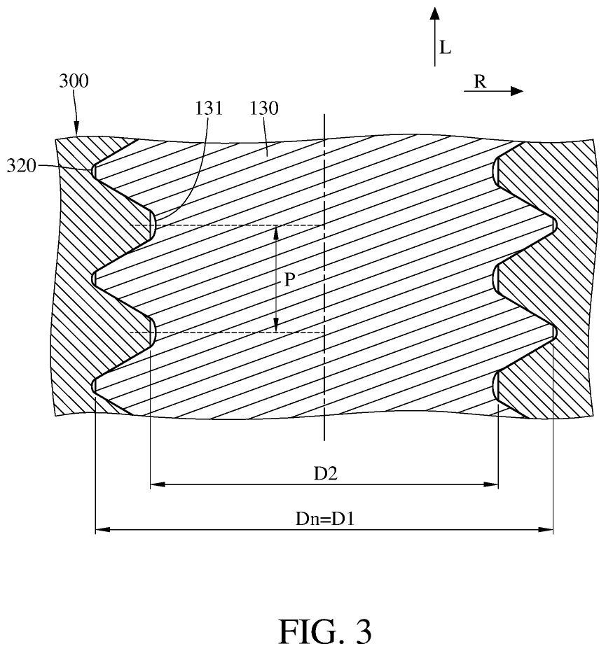

Please refer to FIG. 1 to FIG. 3, wherein FIG. 3 is an enlarged cross-sectional view showing that an engaging part is screwed in a first screw hole of a first base of the mounting assembly in FIG. 1. In this and some embodiments of the present disclosure, the engaging part 130 may further include male threads 131, and the first base 300 may further include first female threads 320 located at the first screw hole 310 of the first base 300. The male threads 131 and the first female threads 320 are made according to standards of ISO metric screw thread, and a nominal outer diameter Dn and a pitch P of the male threads 131 are respectively substantially equal to a nominal outer diameter Dn and a pitch P of the first female threads 320. In other words, the male threads 131 and the first female threads 320 fit each other. As such, the male threads 131 can be engaged with the first female threads 320 so as to screw the screw 100 into the first base 300.

In this and some embodiments of the present disclosure, the largest outer diameter D1 of the engaging part 130 is substantially equal to the nominal outer diameter Dn of the male threads 131 and is substantially larger than the smallest inner diameter D2 of the first screw hole 310, allowing the engaging part 130 to pass through the first base 300. Therefore, the screw 100 can be movably fixed to the first base 300, and this prevents the screw 100 from being missing and saves time on checking the screw specification. In some other embodiments, the male threads and the first female threads may be made according to standards of BSW (British Standard Whitworth) so long as the engaging part can be screwed through the first base via the male threads and the first female threads. In yet some other embodiments, the first screw hole of the first base may not have the first female threads, and the neck part passing through the first screw hole is connected between the head part and the engaging part by, for example, welding.

As shown in FIG. 1 to FIG. 2, in this and some embodiments, an outer diameter D3 of the head part 110 is larger than an outer diameter D4 of the elastic component 200. The head part 110 may further include a contact surface 111 facing the first base 300. The first side 210 of the elastic component 200 presses against the contact surface 111 of the head part 110. The size of the outer diameter D3 ensures the first side 210 of the elastic component 200 is in full contact with the contact surface 111 so that the elastic component 200 can evenly press against the head part 110, but the disclosure is not limited thereto. In some other embodiments, a portion of the elastic component may be not right under the head part so long as the elastic component does not incline and can evenly press against the head part.

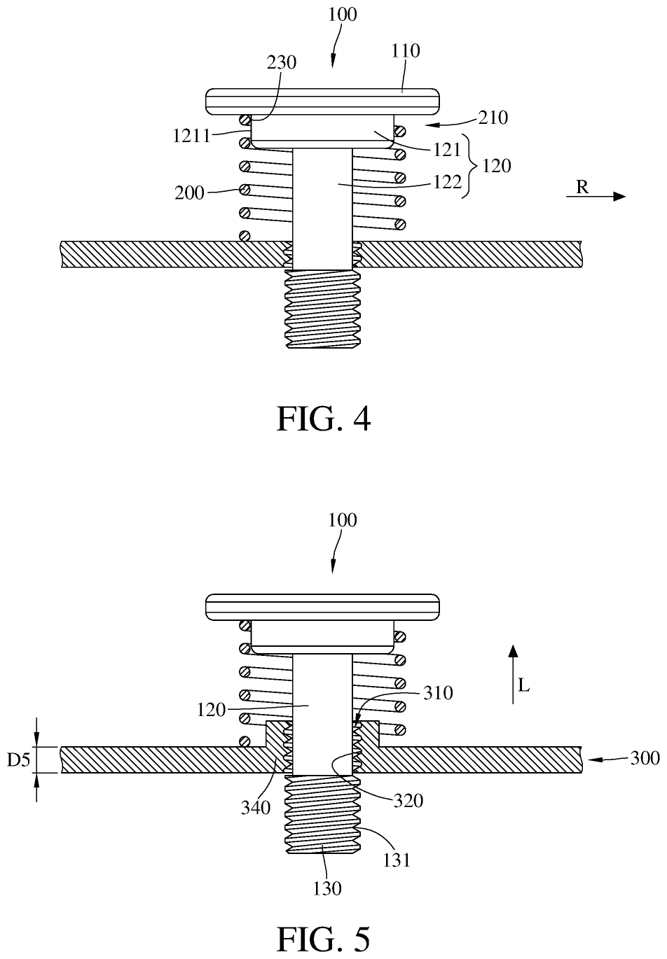

Please refer to FIG. 4, which is a cross-sectional view of a mounting assembly according to another embodiment of the present disclosure. It is noted that only differences from the preceding embodiments are explained below. In this and some embodiments, the neck part 120 may further include a base part 121 and a main part 122. The base part 121 is located between the head part 110 and the main part 122. The base part 121 may further include a circumferential surface 1211, and the elastic component 200 may further include an inner surface 230 in contact with the circumferential surface 1211. Accordingly, the movement of the first side 210 of the elastic component 200 along the radial direction R is restricted, thus ensuring the elastic component 200 is aligned with the screw 100 and able to evenly press against the head part 110. In some other embodiments, the neck part may not include the base part so long as the elastic component can be aligned with the screw and evenly press against the head part.

Please refer to FIG. 5, which is a cross-sectional view of a mounting assembly according to yet another embodiment of the present disclosure. It is noted that only differences from the preceding embodiments are explained below. In this and some embodiments, the first base 300 may further include a first bend part 340 which extends along the longitudinal direction L of the screw 100 and has an inner wall (not numbered) forming the first screw hole 310. In such a case, the first bend part 340 increases the contact area between the neck part 120 and the first base 300, helping to further stable the screw 100 on the first base 300. The first bend part 340 may also ensure the engagement between the first female threads 320 and the male threads 131 is sufficient. Generally, the quantity of the first female threads 320 are more than three coils, thus preventing the male threads 131 or the first female threads 320 from being stripped while screwing the screw 100. Due to the first bend part 340, the thickness D5 of the first base 300 may be thinned regardless the configuration of the first female threads 320.

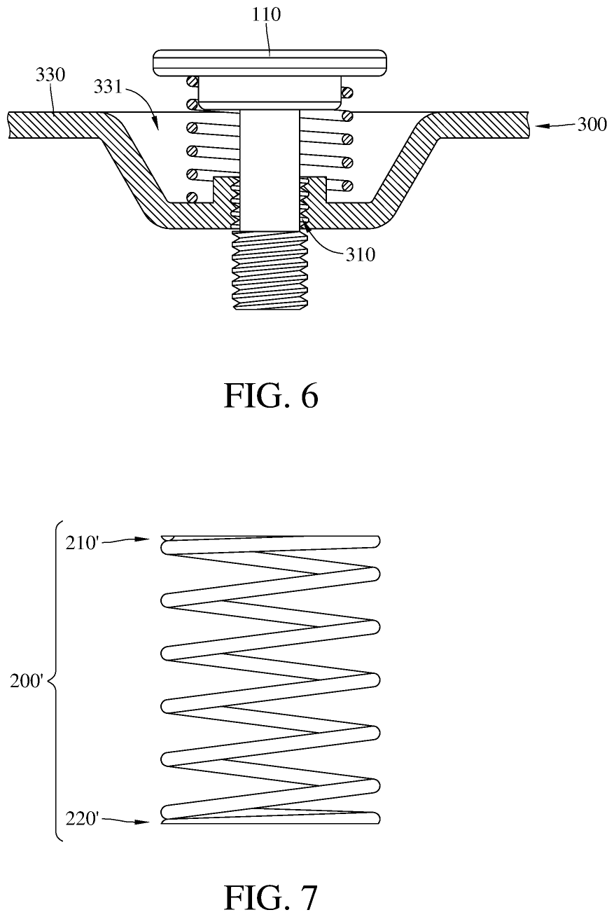

Please refer to FIG. 6, which is a cross-sectional view of a mounting assembly according to still another embodiment of the present disclosure. It is noted that only the differences from the preceding embodiments are explained below. In this and some embodiments, the first base 300 may further include a top surface 330 and a recess 331 which is formed on the top surface 330. The first screw hole 310 is located at the recess 331, and the head part 110 is located in the recess 331. That is, the screw 100 is screwed in the first base 300 in a countersunk head design and does not protrude from the top surface 330. Accordingly, the head part 110 of the screw 100 may not be interfered with other components, and the head part 110 is prevented from interfering with other external components while moving the first base 300 or installing other external components near the top surface 330. In some other embodiments, the first base may not include the recess if the head part would not interfere with other external components.

Note that the elastic component 200 in FIG. 1 may be replaced with another type of compression spring. Please refer to FIG. 7, which is a cross-sectional view of an elastic component of a mounting assembly according to still yet another embodiment of the present disclosure, and only differences from the preceding embodiments are explained below. In this and some embodiments, an elastic component 200′ may be, for example, a compression spring with ground ends. Accordingly, a first side 210′ and a second side 220′ of the elastic component 200′ for respectively pressing against the heat part 110 (as shown in FIG. 1) and the first base 300 (as shown in FIG. 1) are flat, such that the elastic component 200′ can evenly press against the head part 110 and the first base 300.

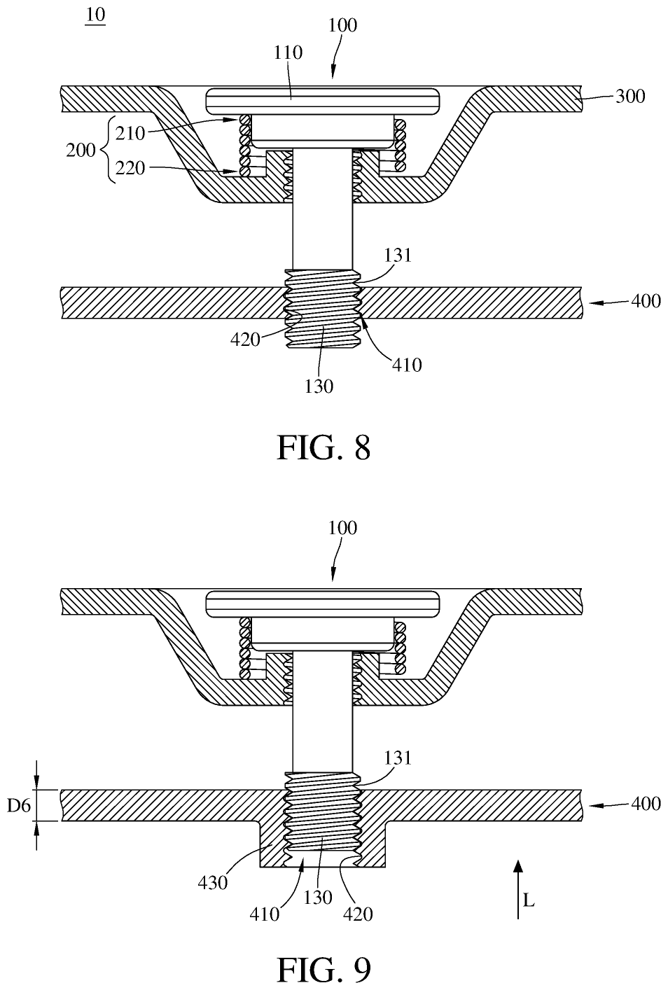

Please refer to FIG. 8, which is a cross-sectional view of a mounting assembly according to still yet another embodiment of the present disclosure. It is noted that only differences from the preceding embodiments are explained below. In this and some embodiments, the mounting assembly 10 may further include a second base 400 (e.g., a portion of a server cabinet) which includes a second screw hole 410 and second female threads 420 located at the second screw hole 410. The second female threads 420 are made according to standards of ISO metric screw thread, and a nominal outer diameter Dn and a pitch P of the second female threads 420 are respectively substantially equal to the nominal outer diameter Dn and the pitch P of the male threads 131. In other words, the male threads 131 and the second female threads 420 fit each other.

As such, the male threads 131 can be engaged with the second female threads 420 so that the engaging part 130 can be screwed in the second screw hole 410 and be detachably disposed on the second base 400. The first base 300 can be mounted to the second base 400 via the screw 100. While mounting the first base 300 to the second base 400, the head part 110 presses the first side 210 of the elastic component 200 toward the first base 300, and the elastic component 200 is compressed between the head part 110 and the first base 300. The elastic component 200 applies a force on the heat part 110 away from the engaging part 130, which helps to the engaging part 130 to further tightly engage with the second base 400. In some other embodiments, the male threads and the second female threads may be made according to standards of BSW so long as the engaging part can be screwed in the second base via the male threads and the second female threads.

In this and some embodiments, the elastic component 200 may have a thick wire diameter; in such a case, the elastic component 200 can maintain a certain amount of thickness while it is compressed tightly, thus ensuring the screw 100 may not be over screwed in the second base 400 so as to prevent the male threads 131 or the second female threads 420 from being stripped. Moreover, the elastic component 200 may have a sufficient length to exert a sufficient force, thus the screw 100 does not need to be deformed slightly and can be made according to the general specifications which is low cost, reusable and is not easily stripped.

Please refer to FIG. 9, which is a cross-sectional view of a mounting assembly according to still yet another embodiment of the present disclosure. It is noted that only differences from the preceding embodiments are explained below. In this and some embodiments, the second base 400 may further include a second bend part 430 which extends along the longitudinal direction L of the screw 100 and has an inner wall (not numbered) forming the second screw hole 410. In such a case, the second bend part 430 may ensure the engagement between the second female threads 420 and the male threads 131 is sufficient. Generally, the quantity of the second female threads 420 are more than three coils, thus preventing the male threads 131 or the second female threads 420 from being stripped while screwing the screw 100. Due to the second bend part 430, the thickness D6 of the second base 400 may be thinned regardless the configuration of the second female threads 420. In some other embodiments, the second base may not include the second bend part so long as the length of the second female threads is sufficient.

According to the mounting assembly discussed above, the head part covers the first screw hole, and the largest outer diameter of the engaging part is larger than the smallest inner diameter of the first screw hole in a radial direction. As a result, the amount of the movement of the screw is restricted by the head part and the engaging part. This prevents the screw from being missing and saves time on pairing the screw with the second screw hole.

In some other embodiments, the male threads and the first female threads may fit each other. As such, the male threads can be engaged with the first female threads so as to screw the screw into the first base.

In some other embodiments, the outer diameter of the head part may be larger than the outer diameter of the elastic component, ensuring the first side of the elastic component is in full contact with the contact surface so that the elastic component can evenly press against the head part.

In some other embodiments, the inner surface of the elastic component may be in contact with the circumferential surface of the base part. Accordingly, the movement of the first side of the elastic component along the radial direction is restricted, thus ensuring the elastic component is aligned with the screw and able to evenly press the head part.

In some other embodiments, the first bend part may increase the contact area between the neck part and the first base, helping to further stable the screw on the first base. The first bend part may also ensure the engagement between the first female threads and the male threads is sufficient, thus preventing the male threads or the first female threads from being stripped while screwing the screw, and allowing the first base may be thinned regardless the configuration of the first female threads.

In some other embodiments, the screw is screwed in the first base in a countersunk head design and does not protrude from the top surface. Accordingly, the head part of the screw may not be interfered with other components, and the head part is prevented from interfering with other external components while moving the first base or installing other external components near the top surface.

In some other embodiments, the elastic component may be a compression spring with ground ends. Accordingly, the first side and the second side of the elastic component for respectively pressing against the head part and the first base are flat, such that the elastic component can evenly press against the head part and the first base.

In some other embodiments, the male threads and the second female threads fit each other. As such, the male threads can be engaged with the second female threads so that the engaging part can be screwed in the second screw hole and be detachably disposed on the second base. The first base can be mounted to the second base via the screw. While mounting the first base to the second base, the head part presses the first side of the elastic component toward the first base, and the elastic component is compressed between the head part and the first base. The elastic component applies a force on the heat part away from the engaging part, which helps to the engaging part to further tightly engage with the second base.

In some other embodiments, the elastic component may have a thick wire diameter; in such a case, the elastic component can maintain a certain amount of thickness while it is compressed tightly, thus ensuring the screw may not be over screwed in the second base so as to prevent the male threads or the second female threads from being stripped. Moreover, the elastic component may have a sufficient length to exert a sufficient force, thus the screw does not need to be deformed slightly and can be made according to the general specifications which is low cost, reusable and is not easily stripped.

In some other embodiments, the second bend part may ensure the engagement between the second female threads and the male threads is sufficient, thus preventing the male threads or the second female threads from being stripped while screwing the screw, and allowing the second base may be thinned regardless the configuration of the second female threads.

The embodiments are chosen and described in order to best explain the principles of the present disclosure and its practical applications, to thereby enable others skilled in the art best utilize the present disclosure and various embodiments with various modifications as are suited to the particular use being contemplated. It is intended that the scope of the present disclosure is defined by the following claims and their equivalents.

What is claimed is:

1. A mounting assembly, comprising:
a screw, comprising a head part, a neck part and an engaging part, wherein the head part and the engaging part are respectively connected to two opposite sides of the neck part;
an elastic component, wherein the neck part is disposed through the elastic component, the elastic component comprising a first side and a second side opposite to each other, and the first side presses against the head part; and
a first base, comprising a first screw hole, wherein the neck part is disposed through the first screw hole, the head part and the engaging part are respectively located at two opposite sides of the first base, and the second side of the elastic component presses against the first base;
wherein a largest outer diameter of the engaging part is larger than a smallest inner diameter of the first screw hole.

2. The mounting assembly according to claim 1, wherein the engaging part further comprises male threads, the first base further comprises first female threads located at the first screw hole, the male threads and the first female threads are made according to standards of ISO metric screw thread, and a nominal outer diameter and a pitch of the male threads are respectively equal to a nominal outer diameter and a pitch of the first female threads.

3. The mounting assembly according to claim 1, wherein an outer diameter of the head part is larger than an outer diameter of the elastic component, the head part further comprises a contact surface facing the first base, and the first side of the elastic component presses against the contact surface.

4. The mounting assembly according to claim 1, wherein the neck part further comprises a base part and a main part, the base part is located between the head part and the main part and further comprises a circumferential surface, and the elastic component further comprises an inner surface in contact with the circumferential surface.

5. The mounting assembly according to claim 1, wherein the first base further comprises a first bend part which extends along a longitudinal direction of the screw and has an inner wall forming the first screw hole.

6. The mounting assembly according to claim 1, wherein the first base further comprises a recess and a top surface forming the recess, the first screw hole is located at the recess, and the head part is located in the recess.

7. The mounting assembly according to claim 1, wherein the elastic component is a compression spring.

8. A mounting assembly, comprising:
a screw, comprising a head part, a neck part and an engaging part, wherein the head part and the engaging part are respectively connected to two opposite sides of the neck part;
an elastic component, wherein the neck part is disposed through the elastic component, the elastic component comprising a first side and a second side opposite to each other, and the first side presses against the head part;
a first base, comprising a first screw hole, wherein the neck part is disposed through the first screw hole, the head part and the engaging part are respectively located at two opposite sides of the first base, and the second side of the elastic component presses against the first base; and
a second base, comprising a second screw hole, wherein the engaging part is detachably disposed to the second base via the second screw hole.
wherein a largest outer diameter of the engaging part is larger than a smallest inner diameter of the first screw hole, and the elastic component is compressed by the head part and the first base.

9. The mounting assembly according to claim 8, wherein the engaging part further comprises male threads, the first base further comprises first female threads located at the first screw hole, the second base further comprises second female threads located at the second screw hole, the male threads, the first female threads and the second female threads are made according to standards of ISO metric screw thread, and a nominal outer diameter and a pitch of the male threads are respectively equal to a nominal outer diameter and a pitch of the first female threads and are also respectively equal to a nominal outer diameter and a pitch of the second threads.

10. The mounting assembly according to claim 8, wherein the second base further comprises a second bend part which extends along a longitudinal direction of the screw and has an inner wall forming the second screw hole.
